(19) United States
(12) Patent Application Publication
(10) Pub. No.: US 2025/0098008 A1
(43) Pub. Date: Mar. 20, 2025

(54) REPORT HANDLING IN MULTIPLE CONNECTION FAILURES

(71) Applicant: Nokia Technologies Oy, Espoo (FI)

(72) Inventors: Malgorzata TOMALA, Wroclaw (PL); Anna PANTELIDOU, Massy (FR)

(21) Appl. No.: 18/727,263

(22) PCT Filed: Jan. 9, 2023
(86) PCT No.: PCT/EP2023/050314

§ 371 Date: Jul. 8, 2024

(30) Foreign Application Priority Data
Jan. 10, 2022 (FI) 20225014

(51) Int. Cl. H04W 76/18; H04W 24/10; H04W 74/0833

(52) U.S. Cl. CPC H04W 76/18; H04W 24/10; H04W 74/0833

(57) ABSTRACT

Embodiments of the present disclosure relate to devices, methods, apparatuses and computer readable storage media of report handling in multiple connection failure. The method comprises receiving, from a second device, a request associated with providing a plurality of CEF reports from the first device; and transmitting, to the second device based on the request, the plurality of CEF reports wherein information related to one or more RACH reports corresponding to the plurality of CEF reports is excluded within the plurality of CEF reports.

### FIELD

Embodiments of the present disclosure generally relate to the field of telecommunication and in particular to devices, methods, apparatuses and computer readable storage media of report handling in multiple connection failures.

### BACKGROUND

Minimization of Drive Test (MDT) is a standardized 3rd Generation Partnership Project (3GPP) feature which involves a User Equipment (UE) in automated collection of measurements and reporting them to the network.

The MDT focus on replacing dedicated and costly drive testing performed for network optimization, which may involve regular users of cellular network and makes usage of their data that are collected anyway, for example, for the mobility purposes.

### SUMMARY

In general, example embodiments of the present disclosure provide a solution of report handling in multiple connection failure.

In a first aspect, there is provided a first device. The first device comprises at least one processor; and at least one memory including computer program codes; the at least one memory and the computer program codes are configured to, with the at least one processor, cause the first device at least to receive, from a second device, a request associated with providing a plurality of Connection Establishment Failure (CEF) reports from the first device; and transmit, to the second device based on the request, the plurality of CEF reports wherein information related to one or more random access channel (RACH) reports corresponding to the plurality of CEF reports is excluded within the plurality of CEF reports.

In a second aspect, there is provided a second device. The second device comprises at least one processor; and at least one memory including computer program codes; the at least one memory and the computer program codes are configured to, with the at least one processor, cause the second device at least to transmit, to a first device, a request associated with providing a plurality of CEF reports from the first device; and receive, from the first device, the plurality of CEF reports wherein information related to one or more RACH reports corresponding to the plurality of CEF reports is excluded within the plurality of CEF reports.

In a third aspect, there is provided a method. The method comprises receiving, from a second device, a request associated with providing a plurality of CEF reports from the first device; and transmitting, to the second device based on the request, the plurality of CEF reports wherein information related to one or more RACH reports corresponding to the plurality of CEF reports is excluded within the plurality of CEF reports.

In a fourth aspect, there is provided a method. The method comprises transmitting, to a first device, a request associated with providing a plurality of CEF reports from the first device; and receiving, from the first device, the plurality of CEF reports wherein information related to one or more RACH reports corresponding to the plurality of CEF reports is excluded within the plurality of CEF reports.

In a fifth aspect, there is provided an apparatus comprising means for receiving, from a second device, a request associated with providing a plurality of CEF reports from the first device; and means for transmitting, to the second device based on the request, the plurality of CEF reports wherein information related to one or more RACH reports corresponding to the plurality of CEF reports is excluded within the plurality of CEF reports.

In a sixth aspect, there is provided an apparatus comprising means for transmitting, to a first device, a request associated with providing a plurality of CEF reports from the first device; and means for receiving, from the first device, the plurality of CEF reports wherein information related to one or more RACH reports corresponding to the plurality of CEF reports is excluded within the plurality of CEF reports.

In a seventh aspect, there is provided a computer readable medium comprising program instructions stored thereon for performing at least the following: receiving, from a second device, a request associated with providing a plurality of CEF reports from the first device; and transmitting, to the second device based on the request, the plurality of CEF reports wherein information related to one or more random access channel, RACH, reports corresponding to the plurality of CEF reports is excluded within the plurality of CEF reports.

In an eighth aspect, there is provided a computer readable medium comprising program instructions stored thereon for performing at least the following: transmitting, to a first device, a request associated with providing a plurality of CEF reports from the first device; and receiving, from the first device, the plurality of CEF reports wherein information related to one or more RACH reports corresponding to the plurality of CEF reports is excluded within the plurality of CEF reports.

Other features and advantages of the embodiments of the present disclosure will also be apparent from the following description of specific embodiments when read in conjunction with the accompanying drawings, which illustrate, by way of example, the principles of embodiments of the disclosure.

### BRIEF DESCRIPTION OF THE DRAWINGS

Embodiments of the disclosure are presented in the sense of examples and their advantages are explained in greater detail below, with reference to the accompanying drawings, where

FIG. 1 illustrates an example environment in which example embodiments of the present disclosure can be implemented;

FIG. 2 shows a signaling chart illustrating a process of report handling in multiple connection failures according to some example embodiments of the present disclosure;

FIG. 3 shows a flowchart of an example method of report handling in multiple connection failures according to some example embodiments of the present disclosure;

FIG. 4 shows a flowchart of an example method of report handling in multiple connection failures according to some example embodiments of the present disclosure;

FIG. 5 shows a simplified block diagram of a device that is suitable for implementing example embodiments of the present disclosure; and

FIG. 6 shows a block diagram of an example computer readable medium in accordance with some embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements. These elements should not be limited by these terms. These terms are only used to distinguish functionalities of various elements. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as fifth generation (5G) systems, Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the future fifth generation (5G) new radio (NR) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR Next Generation NodeB (gNB), a Remote Radio Unit (RRU), a radio header (RH), a remote radio head (RRH), a relay, a low power node such as a femto, a pico, and so forth, depending on the applied terminology and technology. A RAN split architecture comprises a gNB-CU (Centralized unit, hosting RRC, SDAP and PDCP) controlling a plurality of gNB-DUs (Distributed unit, hosting RLC, MAC and PHY). A relay node may correspond to DU part of the IAB node.

The term “terminal device” refers to any end device that may be capable of wireless communication. By way of example rather than limitation, a terminal device may also be referred to as a communication device, user equipment (UE), a subscriber station (SS), a portable subscriber station, a mobile station (MS), or an access terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to Mobile Termination (MT) part of the integrated access and backhaul (IAB) node (a.k.a. a relay node). In the following description, the terms “terminal device”, “communication device”, “terminal”, “user equipment” and “UE” may be used interchangeably.

Although functionalities described herein can be performed, in various example embodiments, in a fixed and/or a wireless network node, in other example embodiments, functionalities may be implemented in a user equipment apparatus (such as a cell phone or tablet computer or laptop computer or desktop computer or mobile IoT device or fixed IoT device). This user equipment apparatus can, for example, be furnished with corresponding capabilities as described in connection with the fixed and/or the wireless network node(s), as appropriate. The user equipment apparatus may be the user equipment and/or or a control device, such as a chipset or processor, configured to control the user equipment when installed therein. Examples of such functionalities include the bootstrapping server function and/or the home subscriber server, which may be implemented in the user equipment apparatus by providing the user equipment apparatus with software configured to cause the user equipment apparatus to perform from the point of view of these functions/nodes.

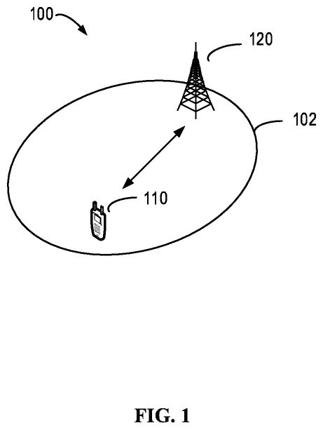

FIG. 1 shows an example communication network 100 in which embodiments of the present disclosure can be implemented. As shown in FIG. 1, the communication network 100 may comprise a terminal device 110 (hereinafter may also be referred to as a UE 110 or a first device 110). The communication network 100 may further comprise a network device 120 (hereinafter may also be referred to as a gNB 120 or a second device 120). The network device 120 can manage a cell 102. The terminal device 110 and the network device 120 can communicate with each other in the coverage of the cell 102.

It is to be understood that the number of network devices and terminal devices shown in FIG. 1 is given for the purpose of illustration without suggesting any limitations. The communication network 100 may include any suitable number of network devices and terminal devices.

As describe above, MDT is introduced for replacing dedicated and costly drive testing performed for network optimization. Two MDT reporting approaches were defined, namely immediate MDT reporting and logged MDT reporting.

The immediate MDT reporting means that the UE generates real time report of radio measurements immediately after performing them. In the logged MDT reporting, the configuration may be performed when UE is in connected mode and the MDT data collection may be performed at the UE when it enters idle mode. Deferred reports in a form of logs may be sent when entering connected mode.

There are two types of deferred reports, namely Radio Link Failure report (RLF report) and Connection Establishment Failure report (CEF report). The RLF report may be built by the UE once it experiences radio link failure on the ongoing connection, while the CEF report may be generated once the UE experiences a failure during attempting to establish a connection.

The MDT measurement results may be put into MDT Trace Records and signalled onwards to Operation, Administration and Maintenance (OAM) entity of the operator for further post-processing.

Currently, it is to be expected that the mechanism of the reporting, for example, in terms of RLF and accessibility measurements and successful Handover reporting can be further improved. Furthermore, as a form of multiple CEF reports is supported, the signalling overhead may be increased due to the multiple CEF reports.

In general, a single CEF report may contain always a cell identity, time stamp, radio measurements, and location information. Besides this default content, a CEF report may also contain in addition a RACH report, in case the UE supports RACH reporting. Thus, the root cause of the size increase is not only due to multiplying a single default report content but also by the information related to Random Access (RA) procedures proceeding the attempted connection.

A RACH report (which can contain up to 8 records of different RA procedures) inclusion into a single CEF report may increase the report size mostly. Multiple CEF reports would require further multiplication of the RACH reports within a CEF report, which may further increase the size of the complete CEF report significantly. In addition, the association of a connection failure with several RACH reports implies another complexity how to associate different RACH reports to a single CEF report and how to separate RACH reports that happen around consecutive connection establishment failures.

Therefore, how to handle the multiple CEF reports and the corresponding RACH reports to limit the signalling overhead may need to be discussed.

The solution of the present disclosure proposes a mechanism of handling of multiple CEF reports. In this solution, the UE may receive a request from the network associated with providing a plurality of CEF reports from the UE. Based on the request, the UE may transmit the plurality of CEF reports wherein information related to one or more random access channel, RACH, reports corresponding to the plurality of CEF reports is excluded within the plurality of CEF reports.

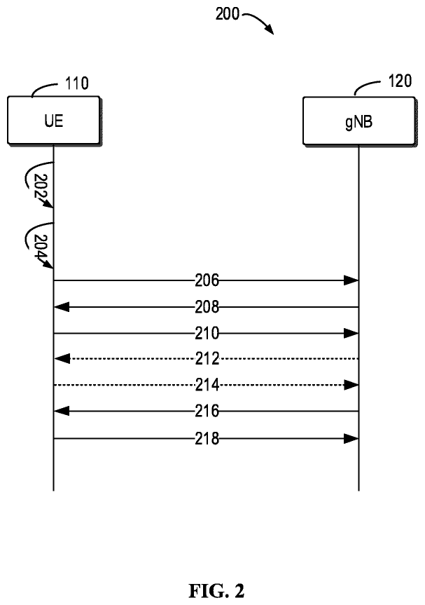

Principle and implementations of the present disclosure will be described in detail below with reference to FIG. 2, which shows a signaling chart illustrating a process 200 of report handling in multiple connection failures according to some example embodiments of the present disclosure. For the purpose of discussion, the process 200 will be described with reference to FIG. 1. The process 200 may involve the UE 110 and the gNB 120.

Now the reference is made to FIG. 2. The UE 110 may perform 202 one or more RA procedures to attempt to connect to the gNB 120. If the UE 110 determines that the connection has not been successfully established, the UE 110 may record 204 CEF report information and the corresponding RACH report information.

As described above, the UE 110 may record information related to multiple CEF reports. It is to be understood that the multiple CEF reports are associated with different instances of a connection failure detected by the UE 110.

After the radio resource connection setup procedure between the UE 110 and gNB 120 has been completed, the UE 110 may transmit 206 to the gNB 120 information associated with the recorded CEF report. In some example embodiments, the information may indicate multiple CEF reports are available at the UE 110. In some example embodiments, it is also possible that the information may indicate one or more RACH reports are available at the UE 110.

After receiving the information, the gNB 120 may transmit 208, a request for the UE 110 to provide the multiple CEF reports to the gNB 120. For example, the request may comprise an indicator, such as a dedicated flag or other suitable indication, for indicating that the multiple CEF reports are to be or allowed to be provided.

Based on the request, the UE 110 may transmit 210, to the gNB 120, a response to the request with the multiple CEF reports. The RACH reports corresponding to the multiple CEF reports may be excluded in the response.

Then a procedure of the retrieval for the recorded RACH reports may be initiated. For example, if the gNB 120 receives the multiple CEF reports without the corresponding RACH reports, the gNB 120 may make aware to the network of the availability of the RACH reports at the UE 110. In this case, the gNB 120 may transmit 216 a request for retrieving the RACH reports to the UE 110. Then the UE 110 may transmit 218 the RACH reports to the gNB 120.

It is also possible that the gNB 120 had received an indication of the availability of the RACH reports at the UE 110 previously, for example, the indication of the availability of the RACH reports at the UE 110 may be included in the information transmitted from the UE 110 to the gNB 120 at the action 206. In this case, the gNB 120 may transmit 216 a request for retrieving the RACH reports to the UE 110. Then the UE 110 may transmit 218 the RACH reports to the gNB 120.

As another option, the gNB 120 may transmit 212, after receiving the multiple CEP reports, an enquiry for a capability of the UE 110 to the UE 110. If the RACH reports are available at the UE 110, the UE 110 may transmit 214 a response to the enquiry indicating the availability of the RACH reports at the UE 110. If the gNB 120 receives the response to the enquiry indicating the availability of the RACH reports at the UE 110, the gNB 120 may transmit 216 a request for retrieving the RACH reports to the UE 110. Then the UE 110 may transmit 218 the RACH reports to the gNB 120.

In the solution of the present disclosure, in some example embodiments, the UE may support multiple connections failures reporting and random access related reporting and transmit the report on random access events as a standalone report.

In some example embodiments, the UE may record the information on multiple connections failures and information on random access related events separately.

In some example embodiments, the UE may notify the network about multiple connections failures report (any instance of the list) availability.

In some example embodiments, the UE may notify the network about random access related report availability.

In some example embodiments, the random access related report may be standalone but related to multiple connections failures report (e.g. random access related information pertain to the connections failures).

In some example embodiments, the UE may send multiple connections failures related report upon network request to report multiple connections failures.

In some example embodiments, the UE may provide the report consisting of a list (i.e. a multiple instances) of a single report, where a single report pertains to a failure event of a single connection. The list and any instance of the list (a single instance of the list) does not include random access related information.

In some example embodiments, the UE may send a random access related report upon network request to report random access related report.

In some example embodiments, the UE may send multiple connections failures report and random access related report in one message upon explicit network request to report both.

In some example embodiments, the gNB in a connection with the UE that supports multiple connections failures report and random access related report may request the UE to provide the information upon receiving the notification about any of the report availability.

In some example embodiments, the gNB may request the UE to provide the multiple connections failures report as a standalone report

In some example embodiments, the gNB may request the UE to provide random access related report as a standalone report (also based on multiple connections failures report (any instance of the list) availability)

In this way, a solution for handling the multiple CEF reports and the corresponding RACH report are proposed to decrease the signalling overhead in the CEF reporting procedure.

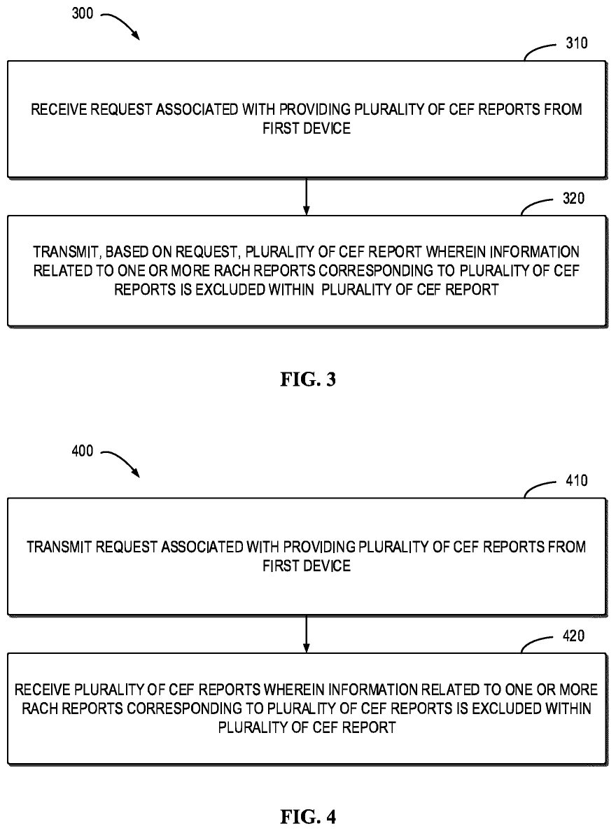

FIG. 3 shows a flowchart of an example method 300 of report handling in multiple connection failure according to some example embodiments of the present disclosure. The method 300 can be implemented at the first device 110 as shown in FIG. 1. For the purpose of discussion, the method 300 will be described with reference to FIG. 1.

At 310, the first device receives, from a second device, a request associated with providing a plurality of CEF reports from the first device.

At 320, the first device transmits, to the second device based on the request, the plurality of CEF reports wherein information related to one or more RACH reports corresponding to the plurality of CEF reports is excluded within the plurality of CEF reports.

In some example embodiments, the first device may transmit, to the second device, information indicating at least one of an availability of the plurality of CEF reports at the first device; and an availability of the one or more RACH reports at the first device.

In some example embodiments, if the first device determines that an indicator for the first device to provide the plurality of CEF reports is obtained from the request, the first device transmits the plurality of CEF reports wherein the information related to the one or more RACH report corresponding to the plurality of CEF reports is excluded within the plurality of CEF reports.

In some example embodiments, the plurality of CEF reports are associated with different instances of a connection establishment failure detected by the first device.

In some example embodiments, the first device may receive, from the second device, a request for retrieving the one or more RACH reports from the first device; and transmit the one or more RACH reports to the second device.

In some example embodiments, the first device may receive, from the second device, an enquiry for a capability of the first device. If the first device determines that the one or more RACH reports are available at the first device, the first device may transmit, to the second device, a response to the enquiry indicating the availability of one or more RACH reports at the first device. The first device may receive, from the second device, a request for retrieving the one or more RACH reports from the first device; and transmit the one or more RACH reports to the second device.

In some example embodiments, the first device comprises a terminal device and the second device comprises a network device.

FIG. 4 shows a flowchart of an example method 400 of report handling in multiple connection failures according to some example embodiments of the present disclosure. The method 400 can be implemented at the second device 120 as shown in FIG. 1. For the purpose of discussion, the method 400 will be described with reference to FIG. 1.

At 410, the second device transmits, to a first device, a request associated with providing a plurality of CEF reports from the first device.

At 420, the second device receives, from the first device, the plurality of CEF reports wherein information related to one or more RACH reports corresponding to the plurality of CEF reports is excluded within the plurality of CEF reports.

In some example embodiments, the second device may receive, from the first device, information indicating at least one of an availability of the plurality of CEF reports at the first device; and an availability of the one or more RACH reports at the first device.

In some example embodiments, the second device may transmit an indicator for the first device to provide the plurality of CEF reports.

In some example embodiments, the second device may transmit, to the first device, a request for retrieving the one or more RACH reports from the first device; and receive the one or more RACH reports to the second device from the first device.

In some example embodiments, in response to a reception of information indicating an availability of one or more RACH reports at the first device, the second device may transmit the request for retrieving the one or more RACH reports.

In some example embodiments, the second device may transmit, to the first device, an enquiry for a capability of the first device. In response to a reception of a response to the enquiry indicating the availability of one or more RACH reports at the first device, the second device may transmit the request for retrieving the one or more RACH reports.

In some example embodiments, the first device comprises a terminal device and the second device comprises a network device.

In some example embodiments, an apparatus capable of performing the method 300 (for example, implemented at the UE 110) may comprise means for performing the respective steps of the method 300. The means may be implemented in any suitable form. For example, the means may be implemented in a circuitry or software module.

In some example embodiments, the apparatus comprises means for receiving, from a second device, a request associated with providing a plurality of CEF reports from the first device; and means for transmitting, to the second device based on the request, the plurality of CEF reports wherein information related to one or more RACH reports corresponding to the plurality of CEF reports is excluded within the plurality of CEF reports.

In some example embodiments, an apparatus capable of performing the method 400 (for example, implemented at the gNB 120) may comprise means for performing the respective steps of the method 400. The means may be implemented in any suitable form. For example, the means may be implemented in a circuitry or software module.

In some example embodiments, the apparatus comprises means for transmitting, to a first device, a request associated with providing a plurality of CEF reports from the first device; and means for receiving, from the first device, the plurality of CEF reports wherein information related to one or more RACH reports corresponding to the plurality of CEF reports is excluded within the plurality of CEF reports.

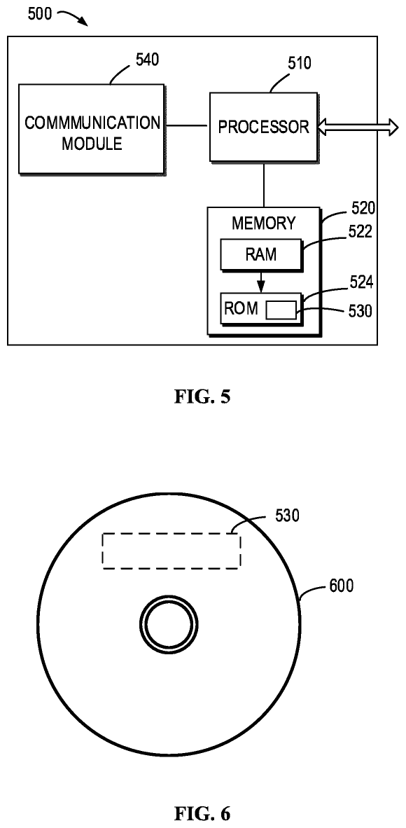

FIG. 5 is a simplified block diagram of a device 500 that is suitable for implementing embodiments of the present disclosure. The device 500 may be provided to implement the communication device, for example the UE 110 as shown in FIG. 1. As shown, the device 500 includes one or more processors 510, one or more memories 540 coupled to the processor 510, and communication modules 540 coupled to the processor 510.

The communication module 540 is for bidirectional communications. The communication module 540 has one or more communication interfaces to facilitate communication with one or more other modules or devices. The communication interfaces may represent any interface that is necessary for communication with other network elements. In some example embodiments, the communication module 540 may include at least one antenna.

The processor 510 may be of any type suitable to the local technical network and may include one or more of the following: general purpose computers, special purpose computers, microprocessors, digital reference signal processors (DSPs) and processors based on multicore processor architecture, as non-limiting examples. The device 500 may have multiple processors, such as an application specific integrated circuit chip that is slaved in time to a clock which synchronizes the main processor.

The memory 520 may include one or more non-volatile memories and one or more volatile memories. Examples of the non-volatile memories include, but are not limited to, a Read Only Memory (ROM) 524, an electrically programmable read only memory (EPROM), a flash memory, a hard disk, a compact disc (CD), a digital video disk (DVD), and other magnetic storage and/or optical storage. Examples of the volatile memories include, but are not limited to, a random-access memory (RAM) 522 and other volatile memories that will not last in the power-down duration.

A computer program 530 includes computer executable instructions that are executed by the associated processor 510. The program 530 may be stored in the ROM 524. The processor 510 may perform any suitable actions and processing by loading the program 530 into the RAM 522.

The embodiments of the present disclosure may be implemented by means of the program 530 so that the device 500 may perform any process of the disclosure as discussed with reference to FIGS. 2 to 4. The embodiments of the present disclosure may also be implemented by hardware or by a combination of software and hardware.

In some embodiments, the program 530 may be tangibly contained in a computer readable medium which may be included in the device 500 (such as in the memory 520) or other storage devices that are accessible by the device 500. The device 500 may load the program 530 from the computer readable medium to the RAM 522 for execution. The computer readable medium may include any types of tangible non-volatile storage, such as ROM, EPROM, a flash memory, a hard disk, CD, DVD, and the like. FIG. 6 shows an example of the computer readable medium 600 in form of CD or DVD. The computer readable medium has the program 530 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, device, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the methods 300 and 400 as described above with reference to FIGS. 3-4. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing device, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, device or processor to perform various processes and operations as described above. Examples of the carrier include a reference signal, computer readable medium, and the like.

The computer readable medium may be a computer readable reference signal medium or a computer readable storage medium. A computer readable medium may include but be not limited to an electronic, magnetic, optical, electromagnetic, infrared, or semiconductor system, device, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1-18. (canceled)

19. A first device comprising:
at least one processor; and
at least one memory including computer program codes;
the at least one memory and the computer program codes are configured to, with the at least one processor, cause the first device at least to:
receive, from a second device, a request associated with providing a plurality of Connection Establishment Failure, CEF, reports from the first device; and
transmit, to the second device based on the request, the plurality of CEF reports wherein information related to one or more random access channel, RACH, reports corresponding to the plurality of CEF reports is excluded from the plurality of CEF reports.

20. The first device of claim 19, wherein the first device is further caused to:
transmit, to the second device, information indicating at least one of:
an availability of the plurality of CEF reports at the first device; and
an availability of the one or more RACH reports at the first device.

21. The first device of claim 19, wherein the transmitting the plurality of CEF reports based on the request is performed in accordance with a determination that an indicator for the first device to provide the plurality of CEF reports is obtained from the request.

22. The first device of claim 19, wherein the plurality of CEF reports are associated with different instances of a connection failure detected by the first device.

23. The first device of claim 19, wherein the first device is further caused to:
receive, from the second device, a request for retrieving the one or more RACH reports from the first device; and
transmit the one or more RACH reports to the second device.

24. The first device of claim 19, wherein the first device is further caused to:
receive, from the second device, an enquiry for a capability of the first device;
in accordance with a determination that the one or more RACH reports are available at the first device, transmit, to the second device, a response to the enquiry indicating the availability of the one or more RACH reports at the first device;
receive, from the second device, a request for retrieving the one or more RACH reports from the first device; and
transmit the one or more RACH reports to the second device.

25. The first device of claim 19, wherein the first device comprises a terminal device, and the second device comprises a network device.

26. A second device comprising:
at least one processor; and
at least one memory including computer program codes;
the at least one memory and the computer program codes are configured to, with the at least one processor, cause the second device at least to:
transmit, to a first device, a request associated with providing a plurality of Connection Establishment Failure, CEF, reports from the first device; and
receive, from the first device, the plurality of CEF reports wherein information related to one or more random access channel, RACH, reports corresponding to the plurality of CEF reports is excluded from the plurality of CEF reports.

27. The second device of claim 26, wherein the second device is further caused to:
receive, from the first device, information indicating at least one of:
an availability of the plurality of CEF reports at the first device; and
an availability of the one or more RACH reports at the first device.

28. The second device of claim 26, wherein the transmitting the request comprises:
transmitting an indicator for the first device to provide the plurality of CEF reports.

29. The second device of claim 26, wherein the second device is further caused to:
transmit, to the first device, a request for retrieving the one or more RACH reports from the first device; and
receive the one or more RACH reports to the second device from the first device.

30. The second device of claim 29, wherein the transmitting the request for retrieving the one or more RACH reports is performed in accordance with a reception of information indicating an availability of the one or more RACH reports at the first device.

31. The second device of claim 29, wherein the transmitting the request for retrieving the one or more RACH reports comprises:
transmitting, to the first device, an enquiry for a capability of the first device; and
in accordance with a reception of a response to the enquiry indicating the availability of the one or more RACH reports at the first device, transmitting the request for retrieving the one or more RACH reports.

32. The second device of claim 26, wherein the first device comprises a terminal device, and the second device comprises a network device.

33. A method comprising:
receiving, from a second device, a request associated with providing a plurality of Connection Establishment Failure, CEF, reports from a first device; and
transmitting, to the second device based on the request, the plurality of CEF reports wherein information related to one or more random access channel, RACH, reports corresponding to the plurality of CEF reports is excluded from the plurality of CEF reports.

34. The method of claim 33, further comprising:
transmitting, to the second device, information indicating at least one of:
an availability of the plurality of CEF reports at the first device; and
an availability of the one or more RACH reports at the first device.

35. The method of claim 33, wherein the transmitting the plurality of CEF reports based on the request is performed in accordance with a determination that an indicator for the first device to provide the plurality of CEF reports is obtained from the request.

36. The method of claim 33, wherein the plurality of CEF reports are associated with different instances of a connection failure detected at the first device.

37. The method of claim 33, further comprising:
receiving, from the second device, a request for retrieving the one or more RACH reports from the first device; and
transmitting the one or more RACH reports to the second device.

38. The method of claim 33, further comprising:
receiving, from the second device, an enquiry for a capability of the first device;
in accordance with a determination that the one or more RACH reports are available at the first device, transmitting, to the second device, a response to the enquiry indicating the availability of the one or more RACH reports at the first device;
receiving, from the second device, a request for retrieving the one or more RACH reports from the first device; and
transmitting the one or more RACH reports to the second device.
